(19) United States
(12) Patent Application Publication
(10) Pub. No.: US 2016/0122129 A1
(43) Pub. Date: May 5, 2016

(54) LIFTING DEVICE AND METHOD FOR LIFTING OBJECT USING LIFTING DEVICE

(71) Applicant: HON HAI PRECISION INDUSTRY CO., LTD., New Taipei (TW)

(72) Inventors: YU-TING WANG, New Taipei (TW); YAN-JYUN CHEN, New Taipei (TW); HSIAO-PING CHIU, New Taipei (TW)

(21) Appl. No.: 14/755,631

(22) Filed: Jun. 30, 2015

(30) Foreign Application Priority Data
Oct. 30, 2014 (TW) 103137554

(51) Int. Cl. B65G 7/12; B25J 1/04; G01L 5/00

(52) U.S. Cl. CPC B65G 7/12; G01L 5/0061; B25J 1/04

(57) ABSTRACT

A lifting device includes a handle, two bottoms coupled to the handle; an area sensor built into the handle and configured to sense a contact area value; a weight sensor built into the handle and configured to sense a gripping force value; two structural members connected to each of the two bottoms which are configured to be coupled to a fixing device of an object; and a control unit, configured to determine whether to have the structural members clamp the object or release the object according to the sensed contact area value and the sensed gripping force value. And a method using the lifting device is also provided.

### CROSS-REFERENCE TO RELATED APPLICATIONS

This application claims priority to Taiwanese Patent Application No. 103137554 filed on Oct. 30, 2014, the contents of which are incorporated by reference herein.

### FIELD

The subject matter herein generally relates to object-lifting device.

### BACKGROUND

A lifting device is labor saving and convenient to use. However, original lifting device is made for a signal product type, it will increase the cost of production. At the same time, it is unable to receive after using. For original lifting device, some items can easily drop from the lifting device creating safety concerns, and does not take into account a user's physiological reaction.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a lifting device.

FIG. 2 is a diagrammatic view of one embodiment of a lifting device on an object.

FIG. 3 illustrates a flowchart of one embodiment of a method for lifting and carrying an object using the lifting device in FIG. 1.

FIG. 4 illustrates a flowchart of one embodiment of a method for releasing an object using the lifting device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

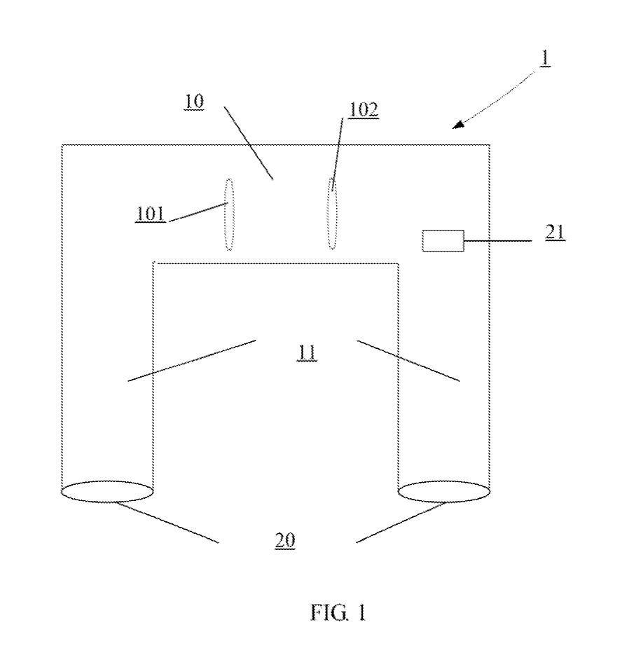

FIG. 1 illustrates a block diagram of one embodiment of a lifting device. In at least one embodiment as shown in FIG. 1, a lifting device 1 includes, but is not limited to, a handle 10 and two bottoms 11 coupled to the handle 10, an area sensor 101, a weight sensor 102, two structural members 20, and a control unit 21. FIG. 1 illustrates only one example of the lifting device 1 that can include more or fewer components than illustrated, or have a different configuration of the various components in other embodiments.

In at least one embodiment, the area sensor 101 and the weight sensor 102 can both be built into the handle 10, the area sensor 101 can sense and monitor a contact area value when a user contacts the handle 10. In some embodiments, the area sensor 101 can be a resistive pressure sensor, or a piezoelectric tactile sensor. The weight sensor 102 can sense and monitor a gripping force value when the user holds and squeezes the handle 10.

In at least one embodiment, the two structural members 20 can be connected to each of the two bottoms 11. In the field of machinery, an independent movement unit can be known as a structural member. The two structural members 20 can connect to a coupled to a fixing device 200 of an object 2. In some embodiments, the two structural members 20 can be cogs, or claws.

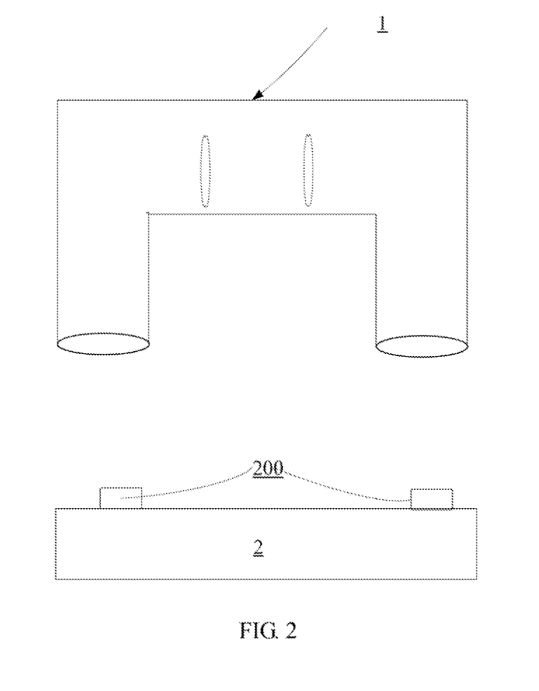

FIG. 2 illustrates a block diagram of one embodiment of a lifting device on an object. In at least one embodiment as shown in FIG. 2, the fixing device 200 can be fixed on the object 2. The fixing device 200 should be corresponding to the two structural members 20. The two structural members 20 and the fixing device 200 can move telescopically. That is to say, when the user hold the handle 10, the two bottoms 11 can first semi-clamp on the fixing device 200, and the structural members 20 become bigger to tightly coupled to the fixing device 200, thus the user can lift the object 2 using the lifting device 1. When the user release the handle 10, the structural members 20 become smaller to separate from the fixing device 200, and two bottoms 11 semi-clamp on the fixing device 200.

In at least one embodiment, the control unit 21 can be a central processing unit (CPU), a microprocessor, or other data processor chip that performs functions of the lifting device 1. The control unit 21 can be capable of electronically connecting to the two structural members 20. The control unit 21 can determine whether the sensed contact area value is larger than a predetermined area value (e.g., ten square centimeters), and determine whether the sensed gripping force value is zero. If a determination is made that the sensed contact area value is larger than the predetermined area value and the sensed gripping force value is non-vanishing, the control unit 21 can control the structural member 20 to clamp the object 2. If a determination is made that the sensed contact area value is zero or less than the predetermined area value, and the sensed gripping force value is zero, the control unit 21 can control the structural member 20 to release the object 2.

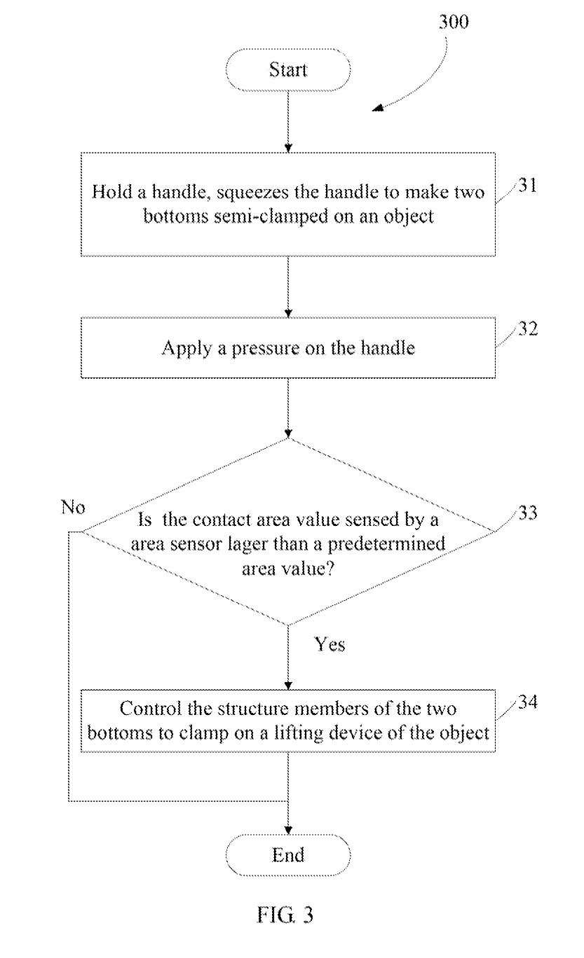

FIG. 3 illustrates a flowchart is presented in accordance with an example embodiment. An example method 300 is provided by way of example, as there are a variety of ways to carry out the method. The example method 300 described below can be carried out using the configurations illustrated in FIG. 1, for example, and various elements of these figures are referenced in explaining example method 300. Each block shown in FIG. 3 represents one or more processes, methods, or subroutines, carried out in the example method 300. Furthermore, the illustrated order of blocks is by example only and the order of the blocks can be changed. The example method 300 can begin at block 31. Depending on the embodiment, additional blocks can be added, others removed, and the ordering of the blocks can be changed.

At block 31, the handle 10 of the lifting device 1 is held by a user, and the two bottoms 11 are pointed at the fixing device 200 of the object 2. Squeezing the handle 10 to make the structural members 20 of the two bottoms 11 semi-clamp on the fixing device 200 of the object 2. In the embodiment, semi-clamp is a condition that the lifting device 1 can be on the object 2 without being secured by the user, the structural members 20 are not clamped on the fixing device 200 completely.

At block 32, a pressure is applied on the handle 10. In some embodiments, the applied pressure can be fifty Newton.

At block 33, the area sensor 101 senses a contact area value, and the control unit 21 determines whether the sensed contact area value is larger than a predetermined area value. If a determination is made that the sensed contact area value is larger than the predetermined area value, the processor goes to block 34. If a determination is made that the sensed contact area value is less than the predetermined area value, the process ends, preventing a mistaken lift.

At block 34, a control unit 21 controls the structural members 20 of the two bottoms 11 to clamp the fixing device 200 of the object 2.

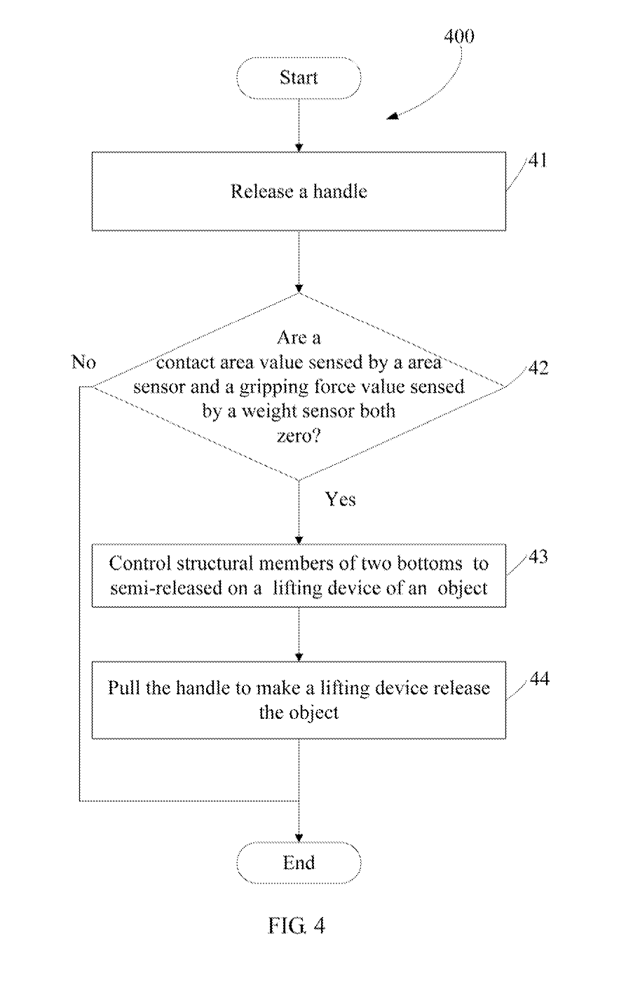

FIG. 4 illustrates a flowchart is presented in accordance with an example embodiment. An example method 400 is provided by way of example, as there are a variety of ways to carry out the method. The example method 400 described below can be carried out using the configurations illustrated in FIG. 1, for example, and various elements of these figures are referenced in explaining example method 400. Each block shown in FIG. 3 represents one or more processes, methods, or subroutines, carried out in the example method 400. Furthermore, the illustrated order of blocks is by example only and the order of the blocks can be changed. The example method 400 can begin at block 41. Depending on the embodiment, additional blocks can be added, others removed, and the ordering of the blocks can be changed.

At block 41, the handle 10 is released by the user.

At block 42, the area sensor 101 senses a contact area value and the weight sensor 102 senses a gripping force value. The control unit 21 determines whether the sensed contact area value and the sensed gripping force value are both zero. If a determination is made that the sensed contact area value and the sensed gripping force value are both zero, the processor goes to block 43. If a determination is made that the sensed contact area value is not zero or the sensed gripping force value is not zero, the processor returns to block 41.

At block 43, a control unit 21 controls the two structural members 20 of the two bottoms 11 to semi-release the fixing device 200 of the object 2.

At block 44, the handle 10 is pulled to make the lifting device 1 release the object 2.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A lifting device comprising:
a handle;
two bottoms coupled to the handle;
an area sensor built into the handle and configured to sense a contact area value;
a weight sensor built into the handle and configured to sense a gripping force value;
two structural members connected to each of the two bottoms which are configured to be coupled to a fixing device of an object; and
a control unit, configured to determine whether to have the structural members clamp the object or release the object according to the sensed contact area value and the sensed gripping force value.

2. The lifting device according to claim 1, wherein when the user hold the handle, the two bottoms first semi-clamp on the fixing device and the structural members become bigger to tightly coupled to the fixing device; when the user release the handle, the structural members become smaller to separate from the fixing device and two bottoms semi-clamp on the fixing device.

3. The lifting device according to claim 2, wherein the structural members comprise claws.

4. The lifting device according to claim 2, wherein the structural member comprise cogs.

5. The lifting device according to claim 1, wherein the fixing device of an object is corresponding to the structural members of the two bottoms.

6. The lifting device according to claim 1, wherein the control unit determines, to clamp the lifting device of the object when the sensed contact area value is determined larger than a predetermined area value, and to release the lifting device of the object when the sensed contact area value and the sensed gripping force value both are zero.

7. The lifting device according to claim 1, wherein the area sensor is a resistive pressure sensor, or a piezoelectric tactile sensor.

8. A method for lifting an object using a lifting device according to claim 1, the method comprising:
sensing a contact area value by a area sensor of the lifting device, when a user contacts the handle;
sensing a gripping force value by a weight sensor of the lifting device, when the user holds and squeezes on the handle;
controlling, using a control unit, the two bottoms to clamp an object, when the sensed contact area value is determined larger than a predetermined area value.

9. The method according to claim 8, further comprising:
controlling, using the control unit, the two structural members of the two bottoms to semi-released on the fixing device of the object, when the sensed contact area value and the sensed gripping force value both are zero; and
controlling, using the control unit, to pull the handle to make the two structural members release the lifting device of the object.

10. The method according to claim 8, wherein before sensing the contact area value and gripping force value, further comprising squeezing the handle to make the structural members of the two bottoms semi-clamp the fixing device of object.

11. The method according to claim 10, wherein the semi-clamp is a condition that the lifting device on the object without the user holding, but the two bottoms are not clamped on the object completely.
